(19) United States
(12) Patent Application Publication
(10) Pub. No.: US 2010/0006076 A1
(43) Pub. Date: Jan. 14, 2010

(54) Breather System for a Four Stroke Engine

(76) Inventors: Nagesh S. Mavinahally, Anderson, SC (US); David R. Brower, Townville, SC (US); Danny C. King, Anderson, SC (US); Brian M. Leinonen, Anderson, SC (US); Phillip T. Scott, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/169,252

(22) Filed: Jul. 8, 2008

(51) Int. Cl. F02B 25/06

(52) U.S. Cl. 123/574

(57) ABSTRACT

A breather system for an engine used to vent combustion, or blow-by, gases. The breather system has an axial breather passage disposed within a camshaft of the engine. A radial opening is in fluid communication with the axial breather passage. A valve is positioned within the radial opening in order to prevent oil from entering the axial breather passage when the engine is not in operation.

### BACKGROUND

The present invention relates to a breather system, more specifically, a breather system that ventilates the valve chamber and the cam chamber of an engine while preventing oil and blow-by gas from being emitted into the atmosphere.

During the use of combustion engines, combustion gases, also known as blow-by gases, are created during combustion in the engine cylinder. In overhead cam engines, these blow-by gases may enter into the valve chamber and the cam chamber through leak paths along the valve stems and the rings. This blow-by gas creates excessive pressure within the valve chamber and the cam chamber and may damage oil seals and other components. Therefore, in order to vent these gases from the valve chamber, the cam chamber, and the crankcase, some engines contain breather systems.

Some breather systems produced today utilize hollow crankshafts or hollow camshafts that are connected to the intake system of the engine. Thus, in operation, breather systems allow for blow-by gases to recirculate into the engine's intake system. However, these breather systems remain open when the engine is no longer in operation. Thus, oil may enter and clog the breather system if the user stores the engine in a non-vertical orientation.

### SUMMARY

According to one embodiment of the present invention, a breather system for an engine comprises a camshaft mounted within a cam chamber, the camshaft having an axial breather passage with an inlet, a radial opening in fluid communication with the inlet of the breather passage, and a valve disposed within the radial opening moveable between an open position and a closed position, wherein the valve is in the closed position when the camshaft is stationary and wherein upon rotation of the camshaft, the valve advances from the closed position to the open position to allow blow-by gas to enter into the breather passage.

According to another embodiment of the present invention, a breather system for an engine comprises an axial breather passage having an inlet and an outlet disposed through a camshaft, the camshaft rotatably positioned within a cam chamber. A generally circular disk is mounted on the camshaft. The disk includes a radial opening in fluid communication with the inlet of the breather passage. A valve is disposed within the radial opening moveable between an open position and a closed position. An oil separation chamber is positioned between the outlet of the breather passage and an intake system in fluid communication with a crankcase of the engine, wherein the valve is in the closed position when the camshaft is stationary and wherein upon rotation of the camshaft, the valve advances from the closed position to the open position to allow gas to enter into the breather passage.

### BRIEF DESCRIPTION OF THE DRAWINGS

FIG. 1 is an overhead cross-sectional view of one embodiment of the breather passage of the present invention, where the breather passage is located in the cam chamber of an engine;

FIG. 2 is an overhead cross-sectional view of another embodiment of the breather passage of the present invention, where the breather passage is located in the cam chamber of an engine:

FIG. 3 is a side view of an embodiment of a camshaft having a dedicated disk to be used in accordance with the present invention;

FIG. 4 is a cross-sectional view of the interior of the camshaft of FIG. 3, where the dedicated disk includes a ball check valve;

FIG. 5 is a cross-sectional view of the interior of the camshaft of FIG. 3, where the dedicated disk includes a decompressor valve;

FIG. 6 is a cross-sectional view of another embodiment of a camshaft to be used in accordance with the present invention.

FIG. 7 is a perspective view of a cam lobe and dedicated disk in accordance with the present invention;

FIG. 8 is a front view of the dedicated disk of FIG. 7, where the decompressor valve is in the closed position;

FIG. 9 is front view of the dedicated disk of FIG. 7, where the decompressor valve is in the open position.

FIG. 10 is a cross-sectional perspective view of the interior of the dedicated disk of FIG. 7, where the decompressor valve is in the closed position;

FIG. 11 is a cross-sectional perspective view of the interior of the dedicated disk of FIG. 7, where the decompressor valve is in the open position; and

FIG. 12 is a side view of an embodiment of an oil separation chamber in accordance with the present invention.

### DETAILED DESCRIPTION OF EMBODIMENTS

The invention is described with reference to the drawings in which like elements are referred to by like numerals. The relationship and function of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

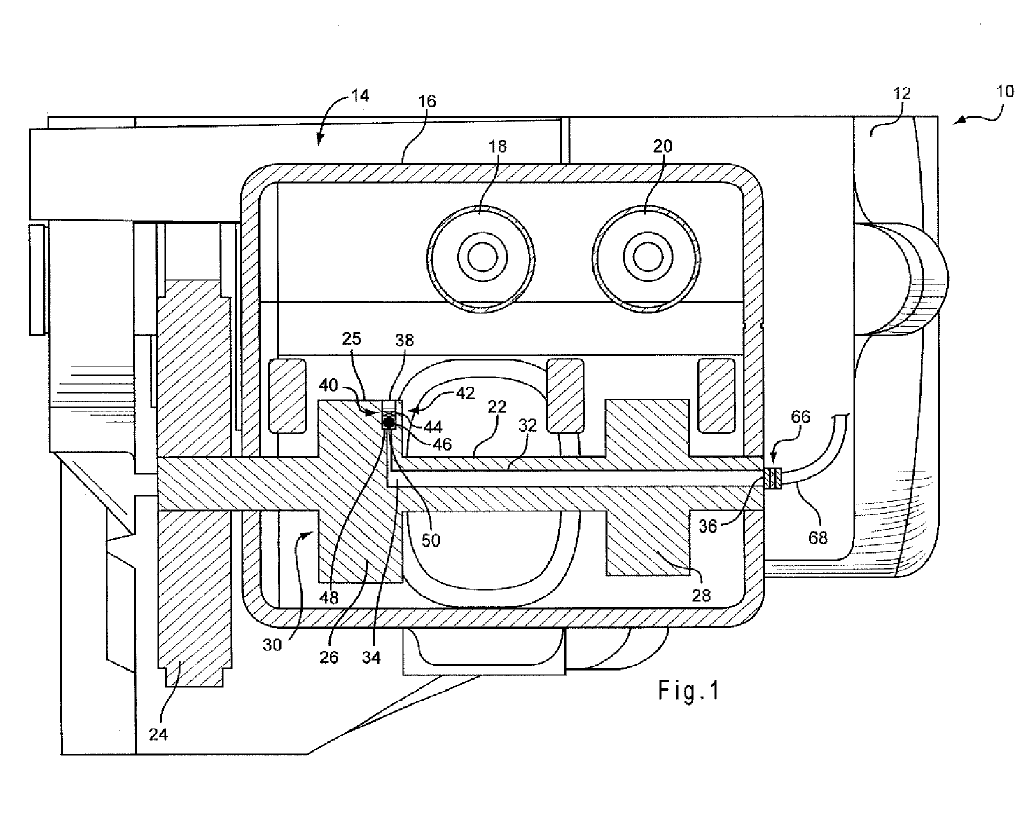

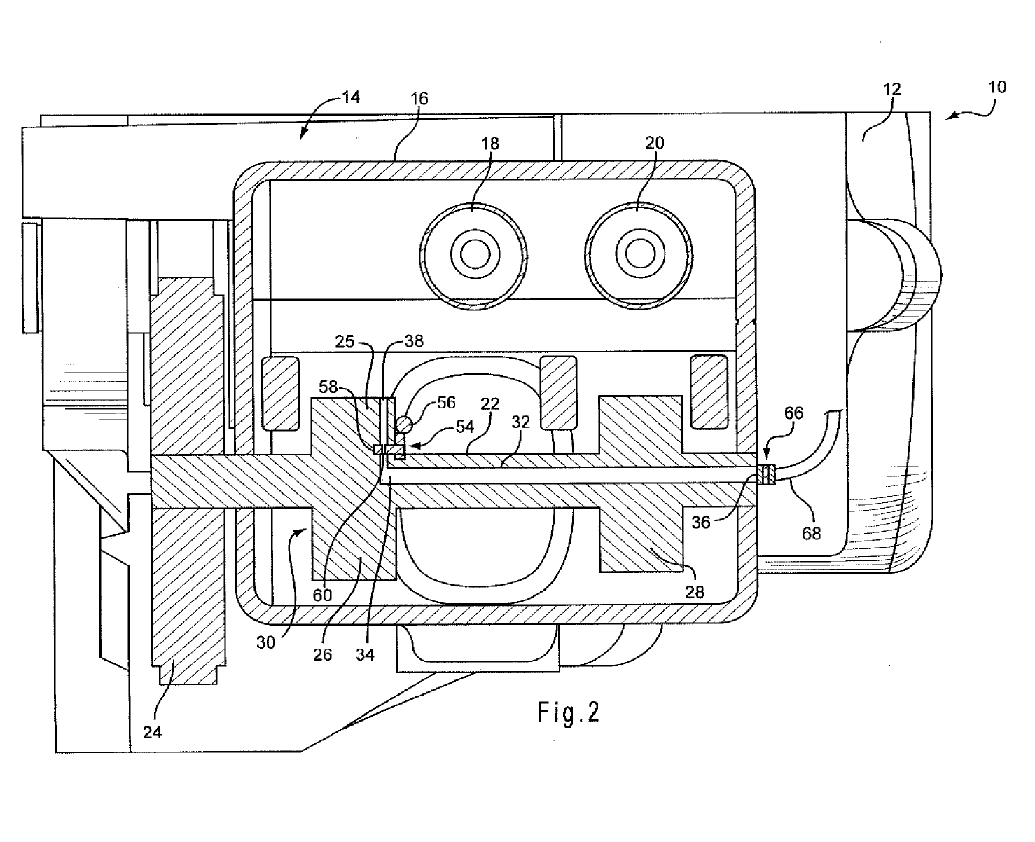

Turning now to the drawings and referring to FIGS. 1 and 2, an engine 10 is shown. The engine 10 is a four-stroke combustion engine having a housing 12 and a cam chamber 14. The cam chamber 14 has sidewalls 16 that may form a completely sealed chamber. Alternatively, a small passage may be in communication a valve chamber and a crankcase of the engine in order to provide mist lubrication of the engine's valve train. An intake valve 18 and an exhaust valve 20 are mounted within the valve chamber of the engine 10. A camshaft 22 is rotatably positioned within the sidewalls 16 of the cam chamber 14. In alternative embodiments, the engine 10 may include more than one camshaft.

The camshaft 22 runs parallel with the intake valve 18 and the exhaust valve 20. The camshaft 22 may be of a generally cylindrical shape and span the entire width of the cam chamber 14. One end of the camshaft 22 is coupled with a cam gear 24. The cam gear 24 is configured to rotate the camshaft 22 when the engine 10 is in use. At least one cam lobe is positioned upon the camshaft 22. Cam lobes 26 and 28 are configured to open the intake valve 18 and the exhaust valve 20, respectively, while the camshaft 22 rotates at half of the speed of the crankshaft. Each cam lobe 26 and 28 include a nose 25. Rocker arms may be provided to work in conjunction with the cam lobes 26 and 28 to open and close the intake valve 18 and exhaust valve 20.

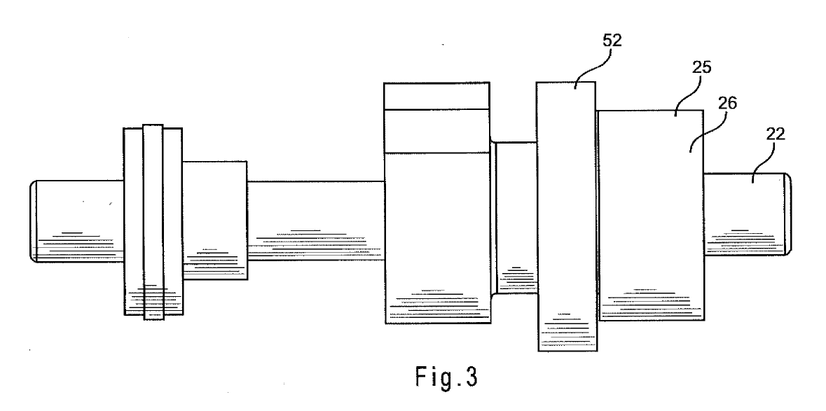

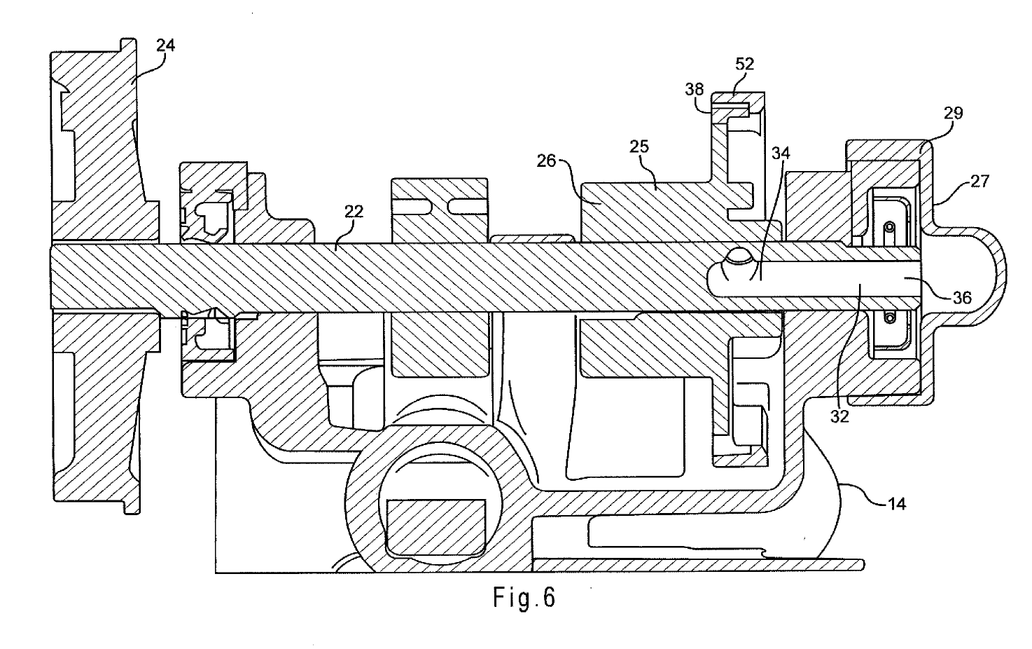

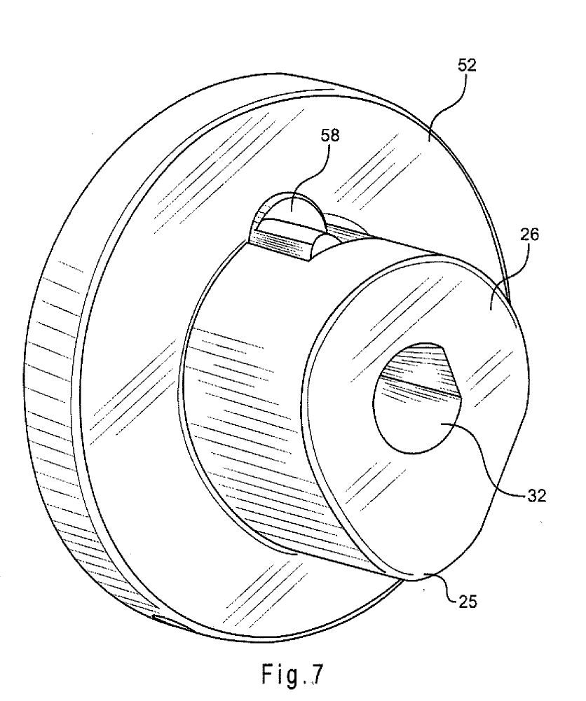

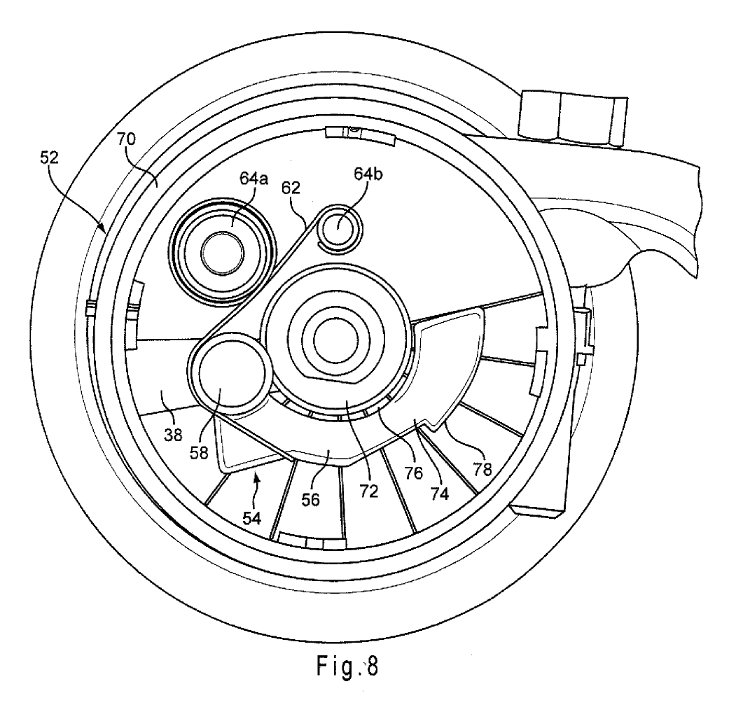

As shown in FIGS. 1 and 2, the engine 10 includes a breather system 30 configured to remove gas pressure from within the cam chamber 14. The breather system 30 includes a breather passage 32 that is disposed axially throughout the camshaft 22. The breather passage 32 includes an inlet 34 and an outlet 36 and is designed to remove blow-by gases located within the cam chamber 14. A radial opening 38 is in fluid communication with the breather passage 32 via the inlet 34. The radial opening 38 is designed to allow blow-by gases to enter into the breather system 30 while the camshaft 22 is in rotation. In the embodiments shown in FIGS. 1 and 2, the radial opening 38 is disposed through the nose 25 of the cam lobe 26. Alternatively, the radial opening 38 may be disposed through a dedicated disk 52 positioned upon the camshaft 22. Referring now to FIG. 3, the dedicated disk 52 is generally circular in shape and is separate from the cam lobe 26. The dedicated disk 52 may also be integral with the cam lobe 26, as shown in FIG. 6. It is contemplated that the dedicated disk 52 may be positioned in different locations along the camshaft 22. As illustrated by FIGS. 7 and 8, the dedicated disk 52 also includes an outer circumference extension 70, which encloses valve components. Referring back to FIG. 6, an oil seal 27 is placed at the end of the camshaft 22 near the outlet 36 of the breather passage 32. A hose fitting 29 may be provided in order to attach a breather hose 68.

As shown in FIGS. 1 and 2, the breather hose 68 is in fluid communication with the outlet 36 of the breather passage 32 and the intake system of the engine 10. Thus, blow-by gases that pass through the breather passage 32 of the camshaft 22 will be recirculated through processed while the engine 10 is in operation. Further, by reprocessing the blow-by gas within the engine 10, the blow-by gas is prevented from being released into the atmosphere. A check valve configured to control the flow of blow-by gases into the intake system of the engine 10 may be positioned at the end of the breather hose 68.

The breather system 30 includes an oil separation chamber 66. The oil separation chamber 66 is configured to separate any oil particles remaining in the blow-by gases prior to the blow-by gases re-entering the intake system of the engine 10. The separated oil flows from the oil separation chamber 66 to the crankcase of the engine 10, which allows the oil to be recycled throughout use of the engine 10. The oil separation chamber 66 is in communication with the outlet 36 of the breather passage 32 and the breather hose 68. In the embodiments shown in FIGS. 1 and 2, the oil separation chamber 66 is mounted upon the cylinder block of the engine 10. In other embodiments, the oil separation chamber 66 may be placed anywhere on the engine 10, including, but not limited to, within the crankcase cover of the engine 10. The oil separation chamber 66 may include wire mesh material 82 or any other suitable oil separation material known to one of ordinary skill in the art.

Referring to FIG. 12, the oil separation chamber 66 includes a control passage 84 in fluid communication with the crankcase of the engine 10. The control passage 84 is designed to have a smaller diameter with respect to the diameter of the breather hose 68. In some embodiments, the diameter of the control passage 84 may be sized to be about one-fifth of the size of the diameter of the breather hose 68. The oil separation chamber 66 also includes a check valve 86 configured to prevent blow by gas and oil from the crankcase chamber to by-pass the breather passage 32 through the camshaft 22. One of ordinary skill in the art would understand that the other types of check valve, such as umbrella valves or reed valves, may be used with this embodiment. The check valve 86 is designed to respond to pressure differences between the crankcase chamber and the oil separation chamber. The check valve 86 normally remains in a closed position, unless the pressure within the crankcase chamber is lower that the pressure within the oil separation chamber 66. The upward motion of the piston lowers the amount of pressure within the crankcase and creates a pressure difference between the crankcase and the oil separation chamber 66, which causes the check valve 86 to move from the closed position to an open position. Conversely, during the downward motion of the piston, the amount of pressure within the crankcase increases. The pressure difference between the crankcase and the oil separation chamber 66 is eliminated, which causes the check valve 86 to return to the closed position. Thus, when the engine 10 is in operation, the check valve 86 continuously opens and closes with respect to the motion of the piston. The condensed oil droplets separated by the wire mesh 82 drop to the bottom of the oil separation chamber 66. When the check valve 86 is in the open position, negative pressure forces created by the pressure difference between the crankcase and the oil separation chamber 66 cause the condensed oil droplets to flow through the control passage 84 and to enter the crankcase.

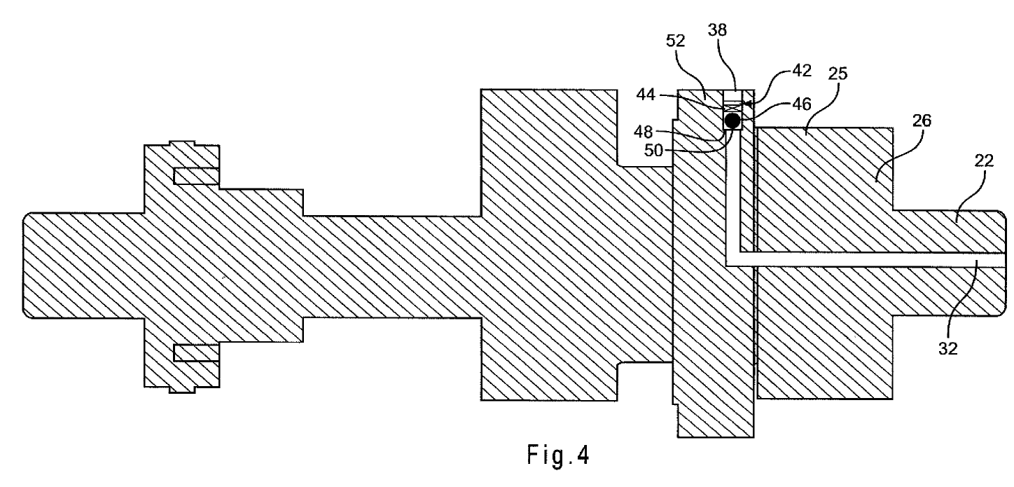

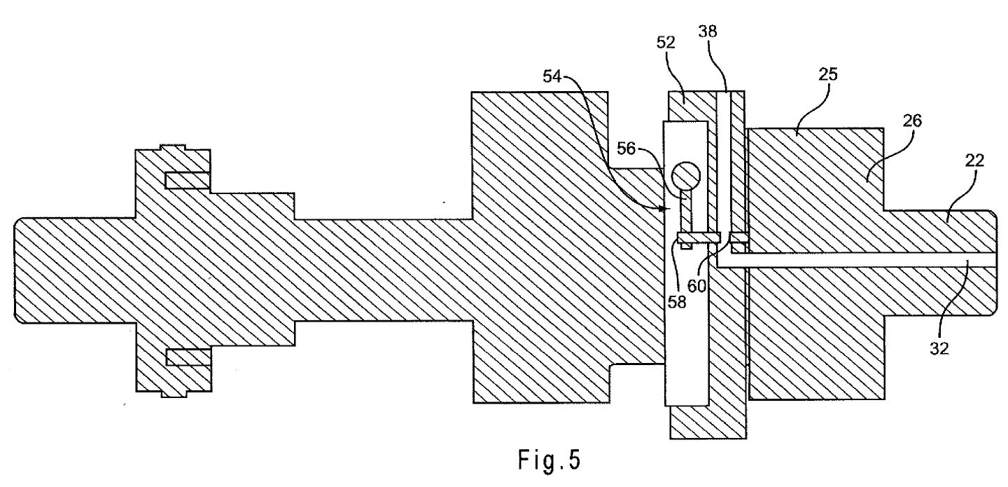

The breather system 30 also includes a valve disposed in the radial opening 38. The valve operates to prevent oil from entering the breather system 30 when the engine 10 is not in operation and is moveable from an open position and a closed position. It is understood that a variety of different valves may be used in combination with the breather system 30. As shown FIGS. 1 and 4, the valve may be a ball check valve 42 loaded with a spring 44. Alternatively, in the embodiments shown in FIGS. 2 and 5-10, the valve may be a decompressor valve 54 including a rotatably mounted decompression weight 56 configured to move upon the application of centrifugal force caused by the rotation of the camshaft 22. The decompressor valve 54 will be discussed in further detail below,

Referring back to FIGS. 1 and 4, the ball check valve 42 includes a spring 44, a ball 46, a seating surface 48, and a through-hole 50. In one embodiment, the spring 44 is a compression spring. It is to be understood, however, that other springs may be suitable for the ball check valve 42. The spring 44 acts to force the ball 46 against the seat 48 to form a seal between the radial opening 38 and the axial breather passage 32 when the engine 10 is not in operation. The seating surface 48 is positioned at one end of the ball check valve 42 and is adapted to receive the ball 46. The seating surface 48 may have number of configurations including, but not limited to, a conical shape or a flat surface. One of ordinary skill in the art would understand that the diameter of the through-hole 50 may be modified based on the given flow rate desired in the breather system 30. Furthermore, the diameter of the ball 46 may be dictated by the diameter of the through-hole 50, the configuration of seat 48, and the desired contact angle between the ball 46 and the seat 48.

In operation, as the engine 10 is driven, the camshaft 22 is rotated at a speed which is half of that of the engine's crankshaft by the cam gear 24. Oil mist, which contains blow-by gases, enters the cam chamber 14. When the oil mist reaches the radial opening 38, the oil particles are separated from the blow-by gases by centrifugal forces. Because the centrifugal forces are greater upon the heavier oil particles than the lighter blow-by gases, the oil particles are prevented from entering the radial opening 38, while the blow-by gases enter into the radial opening 38.

As the camshaft 22 rotates, the ball 46 within the ball check valve 42 compresses the spring 44 due to centrifugal force. As a result, the ball 46 moves away from the seat 48 and opens the through-hole 50. Blow-by gases that enter the radial opening 38 then travel through the through-hole 50 and into the inlet 34 of the breather passage 32. The blow-by gases exit the breather passage 32 through the outlet 36 and enter into the oil separation chamber 66. The blow-by gases pass through the wire mesh material 82 within the oil separation chamber 66, and the heavier oil particles contained within the blow-by gases condense upon the wire mesh material 82. The condensed oil droplets fall to the bottom of the oil separation chamber 66. The upward motion of the piston causes the pressure within the crankcase to decrease creating a pressure differential between the oil separation chamber 66 and the crankcase. The check valve 86 moves from the closed position to the open position continuously. While the check valve 86 is in the open position, negative forces from the crankcase act upon the condensed oil particles such that they flow through the control passage 84 and back into the crankcase. The separated, condensed oil particles are therefore preserved for recycled use during operation of the engine 10. The remaining blow-by gases enter into the breather hose 68 and are reintroduced through the intake system of the engine 10.

When the engine 10 is not in use, the centrifugal forces present at the radial opening 38 and the ball valve 42 no longer exist since the camshaft 22 is not rotating. As a result, the spring 44 presses against the ball 46 to reposition it against the seat 48. This action, which seals the through-hole 50, prevents oil from entering the breather passage 32 through the radial opening 38. This sealing of the breather passage 32 is particularly advantageous when used with four-stroke engines for hand-held devices, such as lawn trimmers, which may placed in different positions during storage by the user.

Referring now to FIGS. 2, 5, and 7-11, the valve may also be a decompressor valve 54, which includes a decompression weight 56 and a pin 58. As shown in FIG. 2, the decompression weight 56 is rotatably mounted to the cam lobe by a pin 58. Alternatively, in another embodiment, the decompression weight 56 is pivotally mounted to the dedicated disk 52 by pin 58. As illustrated by FIGS. 7-11, the components of the decompressor valve 54 are enclosed within the outer circumference extension 70 of the dedicated disk 52. The decompression weight 56 is moveable between an open position and a closed position.

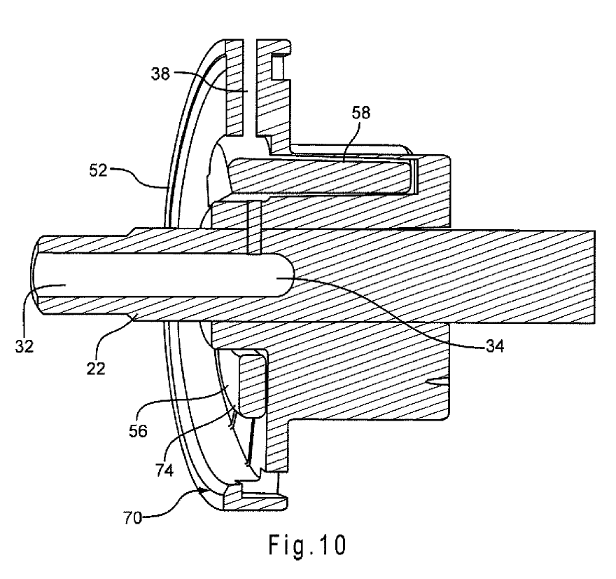

Referring specifically to FIG. 8, the decompression weight 56 is shown in the closed position. The decompression weight 56 is a generally circular arm 74 having an inner surface 76 and an outer surface 78. The inner surface 76 of the decompression weight 56 is generally concave in configuration and is adapted to fit about the inner diameter 72 of the dedicated disk 52 when in the closed position. The inner diameter 72 of the dedicated disk 52 operates as a stop for the decompression weight 56. A torsion spring 62 is coupled to the decompression weight 56 and is supported by protrusions 64a and 64b. The torsion spring 62 is configured to work in conjunction with the inner diameter 72 of the dedicated disk 52 to keep the decompression weight 56 in the closed position when the camshaft 22 is stationary. As shown by FIG. 10, while the decompression weight 56 is in the closed position, the aperture 60 of the pin 58 is not aligned with the radial opening 38. Thus, the pin 58 effectively seals the radial opening 38 and prevents oil from entering the breather system 30 when the engine 10 is not in operation.

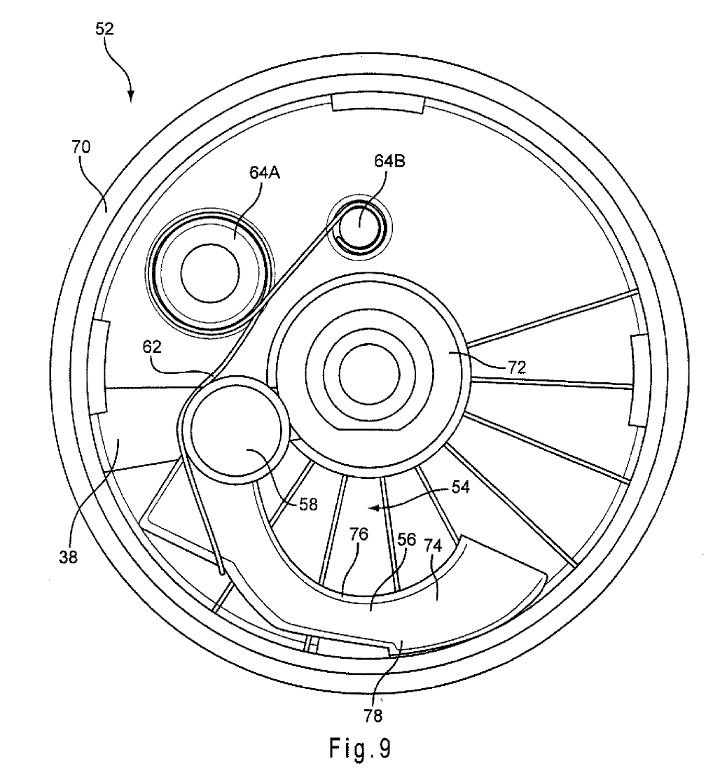

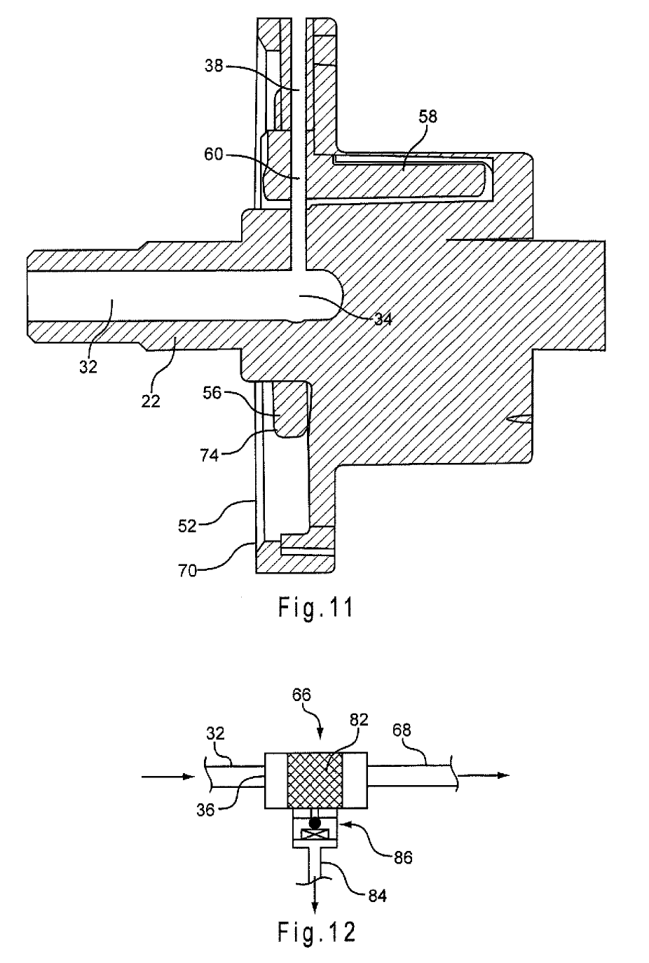

Referring now to FIG. 9, the decompression weight 56 is in the open position. While in the open position, the decompression weight 56 stresses the torsion spring 62. The outer circumference extension 70 operates as a stop for the decompression weight 56 when it is in the open position. As shown by FIG. 11, when the decompression weight 56 is in the open position, the pin 58 is rotated into a position such that the aperture 60 is aligned with the radial opening 38. This alignment of the aperture 60 with the radial opening 38 allows the radial opening 38 to be in fluid communication with the inlet 34 of the breather passage 32. Thus, when the decompression weight 56 is in the open position, blow-by gases are allowed to enter through the breather system 30.

In this particular embodiment, as the engine 10 is driven, the camshaft 22 is rotated at a speed which is half of that of the crankshaft of the engine by the cam gear 24. Oil mist, which contains blow-by gas, enters the cam chamber 14. When the oil mist reaches the radial opening 38, the oil particles are separated from the blow-by gases by centrifugal forces. Because the centrifugal forces are greater upon the heavier oil particles than the lighter blow-by gases, the oil particles are prevented from entering the radial opening 38, while the blow-by gases enter into the radial opening 38.

As the camshaft 22 rotates, the centrifugal forces caused by the rotation act upon the decompression weight 56 and force the inner surface 76 of the decompression weight 56 to disengage the inner diameter 72 of the dedicated disk 52 and to rotate against the spring forces generated by the torsion spring 62. As a result, the decompression weight 56 rotates from the closed position to the open position and stresses the torsion spring 62. The rotation of the decompression weight 56 causes the pin 58 and the aperture 60 to rotate. When the decompression weight 56 reaches the open position, the outer circumference extension 70 stops the rotation of the decompression weight 56. The aperture 60 disposed within the pin 58 aligns with the radial opening 38, which places the radial opening 38 in fluid communication with the breather system 30. Blow-by gases that enter the radial opening 38 then travel through the through-hole 50 and into the inlet 34 of the breather passage 32.

The blow-by gases exit the breather passage 32 through the outlet 36 and enter into the oil separation chamber 66. The blow-by gases pass through the wire mesh material 82 within the oil separation chamber 66, and the heavier oil particles contained within the blow-by gases condense upon the wire mesh material 82. The condensed oil droplets fall to the bottom of the oil separation chamber 66. Vacuum forces created by the upward motion of the piston causes the check valve 86 to move from the closed position to the open position continuously. While the check valve 86 is in the open position, vacuum forces act upon the condensed oil particles such that they flow through the control passage 84 and back into the crankcase. The separated, condensed oil particles 66 are therefore preserved for recycled use during operation of the engine 10. The remaining blow-by gases enter into the breather hose 68 and are reintroduced through the intake system of the engine 10.

When the engine 10 is not in use, the centrifugal forces present at the radial opening 38 and the decompressor valve 54 no longer exist since the camshaft 22 is not rotating. The spring forces generated by the torsion spring 62 press against the decompression weight 56 to rotate the decompression weight 56 from the open position to the closed position. As the decompression weight 56 rotates towards the closed position, the pin 58 rotates and the aperture 60 and the radial opening 38 no longer align. The decompression weight 56 engages the inner diameter 72 of the dedicated disk and stops rotating. This action prevents oil from entering the breather passage 32 while the engine is not in operation and stored by the user.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

1. A breather system for an engine, comprising:
a camshaft rotatably positioned within a cam chamber, the camshaft having an axial breather passage with an inlet;
a radial opening in fluid communication with the inlet of the breather passage; and
a valve moveably positioned within the radial opening, the valve having an open position and a closed position;
wherein the valve is in the closed position when the camshaft is stationary and wherein upon rotation of the camshaft, the valve advances from the closed position to the open position to allow blow-by gases to enter into the breather passage.

2. The breather system of claim 1, wherein the radial opening is disposed through at least one cam lobe positioned on the camshaft.

3. The breather system of claim 1, wherein the valve is a ball check valve.

4. The breather system of claim 3, wherein the ball check valve includes a ball moveable within the valve, a spring engageable with the ball, a seating surface internally positioned at an end of the valve for receiving the ball, and a through-hole disposed through the seating surface in fluid communication with the inlet of the breather system.

5. The breather system of claim 1, wherein the valve is a decompressor including a pin with an aperture and a decompression weight moveable between the closed position and the open position upon the application of centrifugal force and wherein the aperture aligns with the radial opening when the valve is in the open position.

6. The breather system of claim 5, wherein the decompression weight is a generally circular arm having a generally concave inner surface.

7. The breather system of claim 1, further comprising a generally circular disk positioned on the camshaft and wherein the radial opening is disposed through the disk.

8. The breather system of claim 7, wherein the valve is a ball valve.

9. The breather system of claim 8, wherein the ball check valve includes a ball moveable within the valve, a spring engageable with the ball, a seating surface internally positioned at an end of the valve for receiving the ball, and a through-hole disposed through the seating surface in fluid communication with the inlet of the breather system.

10. The breather system of claim 7, wherein the valve is a decompressor valve including a pin with an aperture and a decompression weight moveable between the closed position and the open position upon the application of centrifugal force and wherein the aperture aligns with the radial opening when the valve is in the open position.

11. The breather system of claim 10, wherein the decompressor valve includes a torsion spring wrapped around a protrusion attached to the disk is coupled with the decompression weight to maintain the decompression weight in the closed position when the engine is not in operation.

12. The breather system of claim 10, wherein the decompression weight is a generally circular arm having a generally concave inner surface.

13. The breather system of claim 12, wherein the generally circular disk includes an outer circumferential extension which encloses the valve components.

14. The breather system of claim 13, wherein a stop is formed between the outer circumferential extension and an outer surface of the generally circular arm.

15. The breather system of claim 13, wherein a stop is formed between the inner diameter of the disk and the inner concave surface of the generally circular arm.

16. The breather system of claim 1, wherein an outlet of the breather passage is in fluid communication with an intake system of the engine.

17. The breather system of claim 16, further comprising an oil separation chamber positioned between the outlet of the breather passage and the intake system and is in fluid communication with a crankcase of the engine.

18. A breather system for an engine, comprising:
an axial breather passage having an inlet and an outlet disposed through a camshaft, the camshaft rotatably positioned within a cam chamber;
a generally circular disk mounted on the camshaft, the disk including a radial opening in fluid communication with the inlet of the breather passage;
a valve disposed within the radial opening moveable between an open position and a closed position; and
an oil separation chamber in fluid communication with a crankcase of the engine positioned between the outlet of the breather passage and an intake system;
wherein the valve is in the closed position when the camshaft is stationary and wherein upon rotation of the camshaft, the valve advances from the closed position to the open position to allow gas to enter into the breather passage.

19. The breather passage of claim 18, wherein the valve is a ball valve.

20. The breather passage of claim 18, wherein the valve is a decompressor including a pin having an opening and a decompression weight moveable between the closed position and the open position upon the application of centrifugal force and wherein the aperture aligns with the radial opening when the valve is in the open position.

21. The breather passage of claim 18, wherein the outlet of the breather passage is in fluid communication with an intake system of the engine.
